(19) United States
(12) Patent Application Publication
(10) Pub. No.: US 2015/0149366 A1
(43) Pub. Date: May 28, 2015

(54) METHODS TO NOTIFY USER OF DEAD REMOTE BATTERIES

(71) Applicant: EchoStar Technologies L.L.C., Englewood, CO (US)

(72) Inventors: Adam Schafer, Aurora, CO (US); Jeremy Mickelsen, Denver, CO (US)

(73) Assignee: EchoStar Technologies L.L.C., Englewood, CO (US)

(21) Appl. No.: 14/090,645

(22) Filed: Nov. 26, 2013

(51) Int. Cl. G06Q 30/00; G06Q 10/00; H04N 5/44

(52) U.S. Cl. CPC G06Q 30/016; H04N 5/44; G06Q 10/20
USPC 705/304

(57) ABSTRACT

A method for providing technical support to a user of an electronic device includes requesting that the electronic device transmit a status message to a technical support network. The status message indicates that a component of the electronic device needs attention. The status message is automatically sent to the user to quickly resolve the technical support issue.

### BACKGROUND

1. Technical Field

The present disclosure relates to the field providing technical support to a user of an electronic device.

2. Description of the Related Art

Users of modern electronic devices such as computers, laptops, tablets, smart phones, television receivers, and many other kinds of electronic devices frequently encounter technical problems that they do not know how to resolve. For instance, the user of a new laptop may not be able to connect to the internet, install certain software, or enable certain features of the hardware. Such a user may require technical assistance.

To obtain technical assistance the user may call a technical support phone number which will connect the user to technical support center where the user can obtain assistance from a technical support technician. Alternatively, the user may seek to obtain technical support by accessing a website or a particular part of a website devoted to providing technical support.

Oftentimes a user of an electronic device is very unfamiliar with the electronic device or electronic devices in general. Such a user may have a very difficult time obtaining technical support because he may not have any notion where to begin in describing the problem to a technician so that the technician can begin to understand what area of the hardware or software is the cause of the problem. This can result in a very frustrating phone call for both the technician and the user. The user may become upset and feel like it was a mistake to purchase the electronic device and may wish to get a refund. The user may tell friends and family about the experience and a negative impression of the electronic device and the company that manufactures it may spread, causing harm to the manufacturer or distributor of the electronic device. It is therefore desirable to provide improved technical support to those having difficulties with an electronic device.

### BRIEF SUMMARY

One embodiment is a method for providing technical support to a user of an electronic device. When a user requests technical support with respect to the electronic device, a remote computer in a technical support network requests that the electronic device provide a status message regarding one or more components of the electronic device. The electronic device then transmits to the remote computer the status message regarding one or more components of the electronic device. If the status message indicates that a component of the electronic device is not functioning properly, then a message can be sent to the user of the electronic device indicating what component is faulty and how to proceed to fix it.

In one embodiment a technical support network receives a phone call from a user of a television receiver. When the technical support network receives the phone call from the user, the technical support network ascertains the identity of the user. After the technical support network ascertains the identity of the user, technical support network identifies that the electronic device is associated with the user. The technical support network then transmits a request to the television receiver to provide a status message indicating a charge state of batteries in a remote control associated with the television receiver. If the status message indicates that the batteries are depleted, then a message is transmitted to the user indicating that the batteries should be replaced or recharged.

Thus, as is often the case, the problem with the television receiver may be the result of dead batteries in the remote-control. Before the user can have a frustrating phone conversation with a technical support assistant, the user is automatically informed that the batteries are low and should be replaced. By replacing the batteries the technical problem may be resolved.

### BRIEF DESCRIPTION OF THE SEVERAL VIEWS OF THE DRAWINGS

FIG. 1 is a block diagram of a system including an electronic device of a user, a communication device of a user, and a technical support network according to one embodiment.

FIG. 2 is a block diagram of a technical support network according to one embodiment.

FIG. 3 is an illustration of a user residence and a technical support network according to one embodiment.

FIG. 4 is a block diagram of a remote control and a television receiver according to one embodiment.

FIG. 5 is a flowchart for a method for providing technical support according to one embodiment.

### DETAILED DESCRIPTION

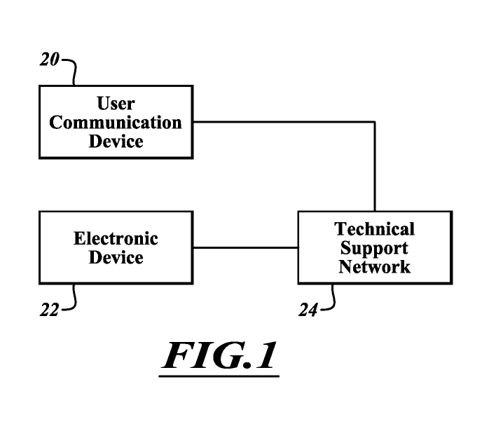

FIG. 1 is a block diagram of a network including a user communication device 20, an electronic device 22, and a technical support network 24. Both the user electronic device 24 and the user communication device 20 are coupled to the technical support network 24.

In one embodiment, a user of the electronic device 22 may experience technical difficulties while operating the electronic device 22. In this situation, the user may contact the technical support network 24 via the user communication device 20. When the user contacts the technical support network 24 using the user communication device 20, the technical support network identifies the user. The technical support network 24 also identifies that the user is associated with the electronic device 22. When the technical support network 24 ascertains that the user that has contacted the technical support network 24 is associated with the electronic device 22, the technical support network 24 sends a request to the electronic device 22 for a status message regarding one or more components of the electronic device 22. The electronic device 22 transmits the status message to the technical support network 24. The status message may indicate that a component of the electronic device 22 is the source of the technical difficulty that the user is experiencing with the electronic device 22.

When the technical support network 24 has received the status message from the electronic device 22, the technical support network 24 transmits the status message to the user 20. In this way, the user 20 is informed that a particular component of the electronic device 22 may be the source of the technical difficulty experienced by the user.

In one embodiment, the user communication device 20 is a phone from which the user has contacted the technical support network 24. Upon receiving the status message from the electronic device 22, the technical support network 24 transmits the status message to the phone. The status message can be transmitted to the phone via a text message, as part of the phone call, or in any other suitable manner.

In one embodiment, the technical support network 24 transmits the status message to a device of the user other than the user communication device 20 by which the user has contacted the technical support network 24. In one example, the technical support network 24 sends an email to an email account associated with the user. Alternatively, the technical support network 24 can cause the electronic device 22 to display the status message to the user.

In one embodiment, the technical support network 24 identifies the user based on the telephone number from which the user is calling. In such an example, the technical support network 24 may have, stored in a database, a telephone number associated with the user. If the user calls from the telephone number associated with the user, then the technical support network 24 identifies the user. The technical support network 24 can then identify that the electronic device 22 is associated with the user. This can be done by referring to a database that stores information regarding the user including what electronic devices are associated with the user. Thus, when the user calls the technical support network 24, the technical support network 24 immediately identifies the user, obtains the status message from the electronic device 22, and transmits the status message to the user upon receiving the phone call from the user. In this example, the user can obtain a resolution to the technical problem without having to speak with a technical support technician.

In one example, when the user contacts the technical support network 24, the user speaks with an automated phone program which requests information from the user, presents selection menus to the user, and provides information to the user. When the user calls the technical support network 24 and presses a number on the phone indicating that the user requests technical support, the automated telephone program can present the status message to the user audibly. The status message can include instructions for fixing or replacing a component of the electronic device 22 which has been identified as causing the problem.

In one embodiment, when the user contacts the technical support network 24, the user communicates with a technical support technician. The technical support network 24 provides the technical support technician with the status message indicating that a component of the electronic device 22 may be causing the problem. The technical support technician then informs the user that a particular component of the electronic device 22 may be causing the problem. In this way, the technical support technician is easily provided with a possible solution to the problem about which the user is calling.

In one example, the electronic device 22 is a television receiver at the residence or place of business of the user. The user may be experiencing technical difficulty in operating the electronic device 22. The user then calls the technical support network 24 to obtain assistance in resolving the problem. Through long experience it has become apparent that when a user is experiencing technical difficulties with a television receiver, the problem is often that the batteries in the remote control which controls the television receiver have gone dead. To prevent the possibility that the user may have to wait on hold for some time until a technical support technician becomes available to speak with the user, the technical support network 24 can obtain from the television receiver 22 information regarding the state of the batteries of the remote control that control the television receiver 22. If the batteries are depleted, then the technical support network 24 can communicate this to the user before the user has had to suffer through waiting on hold to speak with a technical support technician. The user can then replace the batteries or recharge them, and test the television receiver to see if the problem has been resolved. If the problem has been resolved, then there is no further need to contact the technical support network 24. If the problem has not been resolved, then the user can continue waiting to speak to a technical support technician.

The electronic device 22 is not limited to a television receiver, but can also include a computer, a laptop, a tablet, a phone, a car, or any other electronic device about which a user may need to contact the technical support network 24. In one example, the electronic device 22 is an automobile capable of connecting to the technical support network 24. If the operator of the automobile needs technical assistance in operating the automobile, the user can call the technical support network 24. The technical support network 24 can identify the user and can identify that the user is associated with a particular automobile. The technical support network 24 can then send a request to the automobile for a status message. The automobile can transmit a status message to the technical support network 24. The status message can indicate that a component of the automobile such as a battery, an alternator, a particular component of the engine, or some other component of the automobile has become faulty. The technical support network 24 can then communicate to the user the status message. In this way, the user can obtain information regarding the status of the automobile and can quickly ascertain repairs that need to be made. If the repairs are simple repairs which can be performed by the user, then the user can avoid taking the automobile to a repair shop. In this way, the user can save both time and money.

In one example, the electronic device 22 is a computer. The user may be experiencing a technical problem with the computer and may contact the technical support network 24. The technical support network 24 can be contacted by phone or by the computer via the Internet. The technical support network 24 can then transmit a request to the computer for a status message. The computer then transmits to the technical support network 24 a status message indicating that a particular component or components of the computer are faulty or are currently configured in a way that is causing the user technical difficulty. The computer can then display to the user the status message indicating that a particular component of the computer is faulty. In this way, the user can quickly and easily obtain technical support that is likely to be relevant to the problem being experienced by the user.

Thus, the user can contact the technical support network 24 not only by phone but also by accessing a web site via the Internet. The user can interact with the technical support network 24 via the web site. The technical support network 24 can provide a status message to the user as indicated previously. In one embodiment, the status message is presented to the user on a display coupled to the television receiver.

Many other ways of interacting with the technical support network 24 are possible in accordance with the principles of the present disclosure, and will be apparent to those of skill in the art in light of the present disclosure. All such other ways of interacting with the technical support network 24 fall within the scope of the present disclosure.

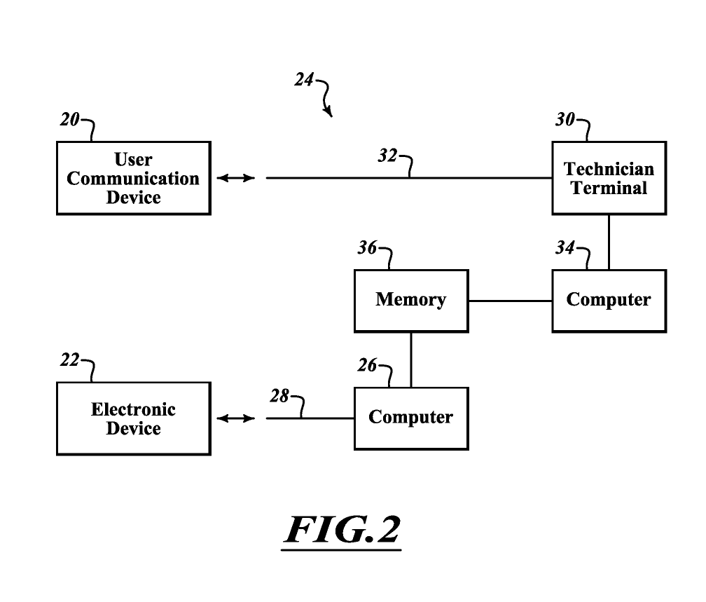

FIG. 2 is a block diagram of a technical support network 24 according to one embodiment. The technical support network 24 includes a computer 26 coupled to the electronic device 22 by a network connection 28. A technician terminal 30 is coupled to the user communication device 20 by a network connection 32. A computer 34 is coupled to the technician terminal 30. A memory 36 is coupled to the computer 26 and the computer 34.

A user of the electronic device 22 contacts the technical support network 24 when he has a difficulty with the electronic device 22. The user contacts the technical support network 24 with the user communication device 20 via the network connection 32. The user communication device 20 is connected to the technician terminal 30, and the user communicates with a technical support technician at the technician terminal 30. When the user contacts the technical support network 24, the computer 34 identifies the user. The computer 34 can identify the user based on an identification of the user communication device 20, or based on information provided by the user. The computer 34 then references a database in the memory 36 and ascertains that the user is associated with the electronic device 22. The computer 34 transmits the identity to the computer 26. The computer 26 transmits a request for a status message to the electronic device 22 via the communication link 28. The electronic device 22 transmits a status message indicating that one or more components of the electronic device 22 are in a condition that could be causing the technical difficulties experienced by the user. The computer 26 receives the status message from the electronic device 22 and transmits it to the computer 34. The computer 34 generates a notification indicating that the one or more components of the electronic device 22 are in a condition which could be causing the technical difficulties experienced by the user. The notification is transmitted from the technician terminal 30 to the user communication device 20 via the communication link 32.

In one embodiment, the notification is transmitted to the user communication device 20 automatically without the assistance of the technical support technician associated with the technician terminal 30. Alternatively, the notification can be sent to the user communication device by the technical support technician at the technician terminal 30. In this case, the technical support technician can speak the notification to the user via the user communication device and network link 32.

In one embodiment, the computer 34 is stationed at the technician terminal 30. The computer 26 can be located in an entirely different part of the world. The computer 26 can be a group of computers.

When the user contacts the technical support network 24 via the user communication device 20, the communication link 32 can be coupled to the computer 26, the computer 34, or to a different computer. As described previously in relation to FIG. 1, the notification can be transmitted to the user communication device 20 without ever communicating with the technician terminal 30. Instead, the computer 26 can cause the notification to be sent directly to the user as soon as the status message is received from the electronic device 22 by the computer 26.

In one embodiment, the communication link 32 is a telephone communication link. In this case, the user communication device 20 is a telephone or smartphone by which the user has called a technical support number in order to communicate with the technical support network 24. Alternatively, the communication link 32 can be an Internet communication link.

In one embodiment, the communication link 28 is an Internet communication link. The electronic device 22 can be connected to the Internet via a modem in the same location as the electronic device 22. The electronic device 22 can communicate via the modem with the computer 26 over the Internet 28. Alternatively, the communication link 28 can be a satellite communication link. In this case, the electronic device 22 communicates with the computer 26 by communicating with a satellite in orbit. The satellite can receive a status message from the electronic device 22 and transmit it to the computer 26.

In one embodiment, the memory 36 includes a bank of electronic storage devices. The electronic storage devices can be one or more hard drives, solid state drives, or other types of computer-readable media. The memory 36 can be at a location or multiple locations remote from both the computer 26 and the computer 34. Alternatively, the memory 36 can be at the same location as the computer 26 and/or the computer 34.

The memory 36 includes a database of user identifications and electronic devices associated with the user identifications. Thus, when the user contacts the technical support network 24, one or more computers of the technical support network 24 can refer to the database stored in the memory 36 to ascertain the user identity and to ascertain that the user is associated with the electronic device 22.

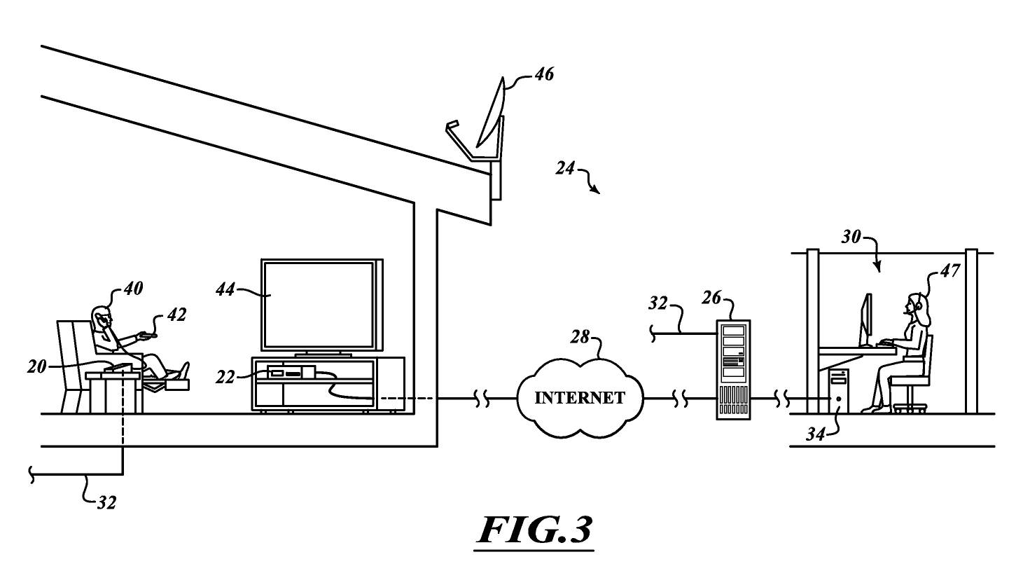

FIG. 3 is an illustration of a residential setting including an electronic device coupled to a technical support network 24 according to one embodiment. A user 40 is at a residence and is attempting to utilize a television receiver 22 by controlling the television receiver 22 with a remote control 42. The television receiver 22 is coupled to a television 44. The television receiver 22 receives television programming signals via a satellite dish 46. The television receiver 22 displays the television content on the television 44. The television receiver 22 is also coupled via the internet 28 to a computer 26 of a technical support network 22. The computer 26 is also coupled to a technician terminal 30 including a computer 34. A technical support technician 47 is at the technical support terminal 30.

As illustrated in FIG. 3, the user 40 is experiencing technical difficulties while attempting to operate the television receiver 22. The user 40 has called the technical support network 24 by using the telephone 20. The telephone 20 connects to the technical support network 24 via the phone line 32 that, while shown as connecting to the computer 26, may connect to the technical support network 24 in any other suitable way. When the user 40 calls the technical support network 24, the computer 26 is notified that a user 40 has contacted the technical support network 24 and seeks technical support to resolve the problem he is experiencing. The computer 26 identifies the user 40 by referring to a database stored in the memory 36 as described previously. The computer 26 can ascertain the identity of the user 40 by identifying that the telephone number of the telephone 20 from which the user is calling is associated with that user. Alternatively, the computer 26 can identify the user based on input the user has provided to the technical support network 24. The computer 26 transmits a request to the television receiver 22 requesting a status message regarding one or more components of the television receiver 22. The request is transmitted to the television receiver 22 via the Internet 28. The television receiver 22 transmits a request to the remote control 42 to provide information regarding the state of the batteries within the remote control 42. The television receiver 22 receives information that the batteries of the remote control 42 are depleted or retrieves stored remote battery information in the event the remote cannot be contacted. The television receiver 22 transmits a status message to the computer 26 via the Internet 28. The status message indicates that the batteries of the remote control 42 associated with the television receiver 22 are depleted. The technical support network 24 generates a notification that the batteries are depleted. The technical support network 24 then transmits to the user 40 the notification indicating that the batteries in the remote control 42 are depleted.

In one embodiment, the technical support network 24 transmits an automated message to the telephone 20 informing the user that the batteries are depleted and should be replaced. Alternatively, a text message can be sent to a cell phone of the user 40, or an email can be sent to an email account of the user 40. In one embodiment, the computer 26 causes the television receiver 22 to display the notification on the television 44. In one embodiment, the notification is sent to the computer 34 at which a technical support technician 47 is working. The technical support technician 47 can then audibly speak to the user 40 informing him that the batteries in the remote control 42 are depleted and should be replaced.

In one embodiment, the status message is regarding something other than the batteries in the remote control 42. For example, the television receiver 22 may determine that a signal strength of control signals received from the remote control 42 are unusually weak. In this case the user 40 may have arranged furniture at his residence in such a way that control signals are completely or partially blocked from the television receiver 22. In this case, the status message can be that the television receiver is obstructed from the remote control 42. The notification can be transmitted to the user indicating that the user should rearrange his furniture in order to ensure that the television receiver 22 is not obstructed from receiving control signals from the remote control 42.

The television receiver 22 can also provide a status message indicating that a component internal to the television receiver 22 has become defective or is configured such that it is causing the user to experience technical difficulties. For example, the television receiver 22 can indicate that an output between the television 44 and the television receiver 22 is incorrectly configured such that audio or video signals from the television receiver 22 are not properly received by the television 44. Likewise, an internal circuit can have become defective, and the status message can indicate this.

It will be apparent to those of skill in the art that many other types of status messages and methods for reporting the status message to the user 40 can be implemented in accordance with principles of the present disclosure. All such status messages and methods for informing the user 40 of the status message fall within the scope of the present disclosure.

While the technical support network 24 has been illustrated with a first computer 26 and a second computer 34 at the technician terminal 30, the first computer 26 may correspond to a network of computers, servers, processors, data storage sites, etc. The network of computers, servers, etc may be in diverse locations. When the user contacts the technical support network 24 via the phone line 32, one of the computers or servers of the network may first receive the call. Those of skill in the art will recognize that there are many ways to implement a technical support network in accordance with principles of the present disclosure. All such implementations fall within the scope of the present disclosure.

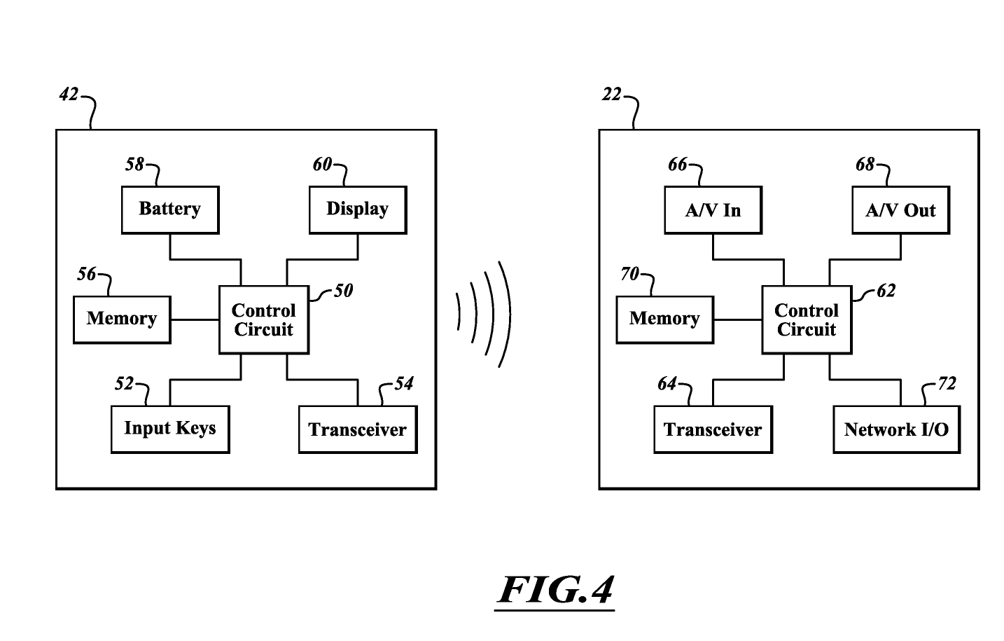

FIG. 4 is a block diagram of the remote control 42 and the television receiver 22 according to one embodiment. The remote control 42 includes a control circuit 50, input keys 52 coupled to the control circuit 50, and a transceiver 54 coupled to the control circuit 50. A memory 56 is also coupled to the control circuit 50. A battery 58 is coupled to the control circuit 50. A display 60 is also coupled to the control circuit 50.

The television receiver 22 includes a control circuit 62. A transceiver 64 is coupled to the control circuit 62. A memory 70, a network I/O 72, audio/video input 66, and audio/video output 68 are also coupled to the control circuit 62.

The remote control 42 controls the television receiver 22 by transmitting from the transceiver 54 control signals to the television receiver 22. The control signals can indicate that the channel should be changed, the volume should be increased, that a programming guide should be accessed, that a DVR menu should be accessed, or that video should be paused, rewound, or fast-forwarded. The user can input commands to the control circuit 50 by pressing the input keys 52. The input keys 52 can include typical number keys, rewind, fast-forward, play, pause, and stop keys, keys indicating which device should be controlled, and other keys such as are well known to those of skilled in the art. Other inputs such as touchpads, touch screens, pointing interfaces may also be included in the remote. The control circuit 50 can store in the memory 56 particular codes to be included in the control signals sent to the television receiver 22. The battery 58 supplies power to the control circuit 50 and all the other components of the remote control 42. The display 60 can provide indications to the user regarding the function of the remote control 42 or the television receiver 22.

The transceiver 64 of the television receiver 22 receives the control signals from the remote control 42 and provides them to the control circuit 62. The control circuit 62 can then cause output signals such as audio or video output signals to be output to a television 44 via the audio/video output 68. Television signals can be received from a satellite or cable television provider via the audio/video input 66. The control circuit 62 can store in memory recorded programs, control signals, or status reports from the remote control. The network I/O 72 can be connected to the Internet and can transmit and receive information via the Internet thereby.

The remote control 42 can transmit status signals regarding the charge state of batteries 58. In particular, the control circuit 50 can monitor the charge state of the battery 58 and can transmit the charge state of the battery 58 to the television receiver 22. The control circuit 62 can receive the status message regarding the charge state of the battery, and can store it in the memory 70. When the user of the remote control 42 contacts technical support as described previously, and the technical support network 24 transmits a request to the television receiver 22 for a status message, the request is received via the network I/O 72. The control circuit 62 then retrieves from the memory 70 the most recent status message regarding the charge state of the batteries 58 of the remote control 42. Alternatively, when the control circuit 62 receives the requests for the status message, the control circuit 62 can control the transceiver 64 to transmit a request for a status message from the remote control 42. In response to receiving the request, the remote control 42 can transmit to the television receiver the status message regarding the batteries 58. The television receiver 22 can then transmit the status message to the technical support network 24 via the network I/O 72.

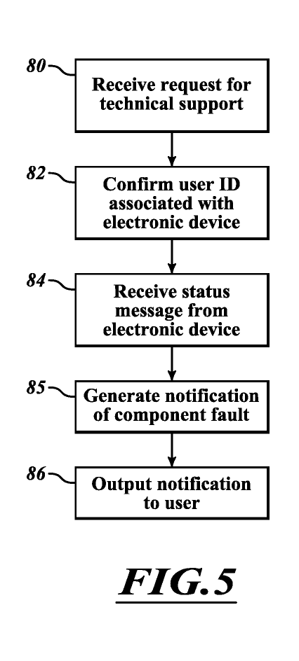

FIG. 5 is a flowchart of a method for providing technical support to a user of an electronic device according to one embodiment. At 80, the technical support network 24 receives a request for technical support from a user of the electronic device 22. At 82, the technical support network 24 ascertains the identity of the user and confirms that the user is associated with the electronic device 22. At 84, a status message is received from the electronic device regarding a component of the electronic device that may be causing the technical problem that the user is experiencing. At 85, the technical support network 24 generates a notification that a component of the electronic device 22 is faulty or configured in such a way that the user is experiencing technical difficulties. At 86, the technical support network 24 outputs a notification to the user indicating that the component of the electronic device 22 is faulty or is improperly configured.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving a request for technical support from a user of a television receiver;
receiving, at a computer, a signal from the television receiver indicative of a state of batteries in a remote control associated with the television receiver;
retrieving from a database an identity of the user;
ascertaining that the user is associated with the television receiver based on the identity; and
generating, at the computer, a notification that the batteries are in a depleted state.

2. The method of claim 1 comprising transmitting the notification to the user.

3. The method of claim 2 wherein transmitting the notification comprises displaying the notification on a display coupled to the television receiver.

4. The method of claim 3 wherein transmitting the notification comprises transmitting the notification to a telephone of the user.

5. The method of claim 2 comprising transmitting the notification to a technical support technician assisting the user.

6. The method of claim 1 comprising retrieving the identity based on a telephone number of a telephone from which the request was received.

7. The method of claim 6 wherein the notification is an audio signal, the method comprising transmitting the notification to the telephone.

8. The method of claim 1 comprising transmitting a request to transmit the state of the batteries to the television receiver in response to identifying the user.

9. The method of claim 8 comprising transmitting the state of the batteries from the television receiver in response to receiving, at the television receiver, the request to transmit the state of the batteries.

10. A method comprising:
receiving, at a first location, a request for technical assistance from a user at a second location remote from the first location;
receiving, at the first location, a status message from an electronic device of the user, the status message indicating a status of a component of the electronic device;
generating, in a computer at the first location, a notification indicating a status of the component;
receiving an identification of the user;
ascertaining that the user is associated with the electronic device by referring to a database; and
transmitting the notification to the user.

11. The method of claim 10 comprising transmitting the notification to a telephone of the user.

12. The method of claim 11 comprising displaying the notification on a display screen at the second location.

13. The method of claim 10 wherein the electronic device is a remote control.

14. The method of claim 13 wherein the component is one or more batteries.

15. The method of claim 14 wherein the status message indicates a charge level of the batteries.

16. A system comprising:
a television receiver configured to display television content on a display coupled to the television receiver;
a computer network configured to:
receive a status message from the television receiver;
receive a request for technical support from a user of the television receiver;
receive an identification of the user;
ascertain that the user is associated with the television receiver by referring to a database; and
generate a notification indicating a problem with equipment of the user based on the status message.

17. The system of claim 16 wherein the computer network is configured to transmit the notification to a technical support technician.

18. The system of claim 17 wherein the computer network is configured to transmit the notification the user.

19. The system of claim 16 wherein the notification indicates that batteries of a remote control associated with the television receiver are depleted.

20. The system of claim 16 wherein the notification indicates that a signal strength of signals received by the television receiver form a remote control associated with the television receiver are weak.
